(19) United States
(12) Patent Application Publication
(10) Pub. No.: US 2017/0082964 A1
(43) Pub. Date: Mar. 23, 2017

(54) IMAGE FORMING APPARATUS AND PRINTING METHOD

(71) Applicants: KABUSHIKI KAISHA TOSHIBA, Tokyo (JP); TOSHIBA TEC KABUSHIKI KAISHA, Tokyo (JP)

(72) Inventor: Osamu Namura, Yokohama (JP)

(21) Appl. No.: 15/364,484

(22) Filed: Nov. 30, 2016

Related U.S. Application Data
(63) Continuation-in-part of application No. 14/739,403, filed on Jun. 15, 2015.

(51) Int. Cl. G03G 15/00; G03G 15/01

(52) U.S. Cl. CPC G03G 15/5062; G03G 15/01

(57) ABSTRACT

In accordance with one embodiment, an image forming apparatus includes a printing section configured to execute at least a decolorable printing; a input section configured to receive a command from a user; a first print control section configured to execute a test printing of a printing subject image by controlling the printing section when receiving a printing command from the user, and then wait until a command is input from the user; and a second print control section configured to print the printing subject image when receiving a command to continue printing from the user after the test printing is executed by the first print control section. The test printing executed by the first print control section is the decolorable printing.

### CROSS-REFERENCE TO RELATED APPLICATIONS

This application is a Continuation-in-Part application of U.S. patent application Ser. No. 14/739,403 filed on Jun. 15, 2015, the entire contents of which are incorporated by reference herein.

### FIELD

Embodiments described herein relate generally to an image forming apparatus and a printing method.

### BACKGROUND

There is known an apparatus having a test printing function. A test printing is a printing for confirming a printing result in advance.

There is a case in which the result of the test printing does not meet the intended result of a user. In this case, sheets the test printing is executed will be totally wasted.

### BRIEF DESCRIPTION OF THE DRAWINGS

FIG. 1 is a diagram illustrating a printing system includes an image forming apparatus according to an embodiment;

FIG. 2 is a block diagram of the image forming apparatus;

FIG. 3 is a diagram illustrating an example of the image forming apparatus;

FIG. 4 is a block diagram illustrating the functions of a control section;

FIG. 5 is a flowchart of a printing processing;

FIG. 6 is a flowchart of a test printing processing;

FIG. 7 illustrates a sheet on which a mark is printed in a place where stapling is scheduled;

FIG. 8 illustrates a sheet on which circles are printed in a place where punching holes is scheduled;

FIG. 9 illustrates an example of a confirmation screen;

FIG. 10 illustrates an example of a printing setting screen; and

FIG. 11 illustrates a sheet on which a dashed line is printed in a place where bending is scheduled.

### DETAILED DESCRIPTION

In accordance with an embodiment, an image forming apparatus includes a printing section configured to execute at least a decolorable printing; a input section configured to receive a command from a user; a first print control section configured to execute a test printing of a printing subject image by controlling the printing section when receiving a printing command from the user, and then wait until a command is input from the user; and a second print control section configured to print the printing subject image when receiving a command to continue printing from the user after the test printing is executed by the first print control section. The test printing executed by the first print control section is the decolorable printing.

Embodiments will be described below with reference to the accompanying drawings. The same or equivalent elements are indicated with the same reference signs in figures.

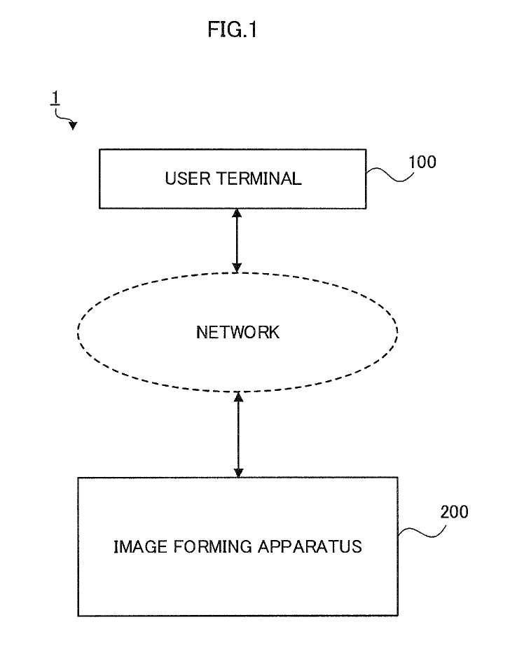

FIG. 1 is a diagram illustrating a printing system including an image forming apparatus according to the embodiment. The printing system 1 includes a user terminal 100 and an image forming apparatus 200. The user terminal 100 and the image forming apparatus 200 are connected with each other via a network.

The user terminal 100 is a user operation terminal such as a personal computer, a portable terminal (for example, a mobile phone, a smart phone, and a tablet device), and the like. The user terminal 100 communicates with the image forming apparatus 200 according to an instruction of the user.

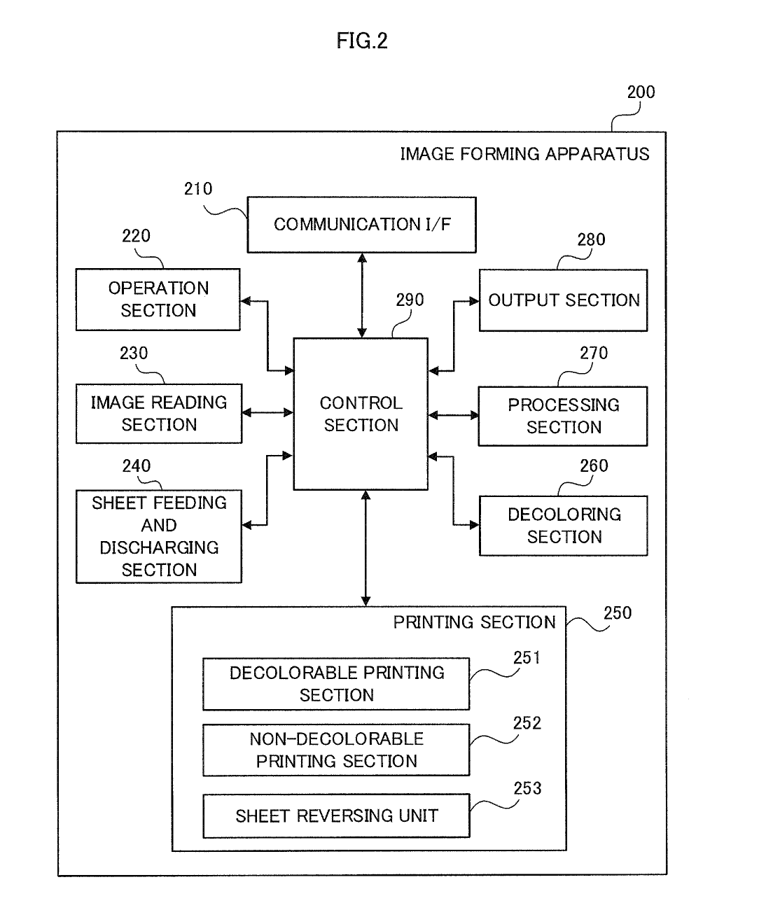

The image forming apparatus 200 is a printing device such as a copier and the like. As illustrated in FIG. 2, the image forming apparatus 200 includes input sections (a communication interface 210, and an operation section 220), an image reading section 230, a sheet feeding and discharging section 240, a printing section 250, a decoloring section 260, a processing section 270, an output section 280, and a control section 290.

The communication interface 210 is a network connection device such as NIC (Network Interface Card), a wireless network adapter and the like. The communication interface 210 connects the image forming apparatus 200 to the network. The communication interface 210 functions as an input section for receiving the printing command from the user who operates the user terminal 100. The communication interface 210 communicates with the user terminal 100 under the control of the control section 290.

The operation section 220 is an input device such as a button, a switch, a touch panel, and the like. The operation section 220 functions as an input section for receiving the printing command from the user. The operation section 220 notifies the control section 290 of the input form the user.

The image reading section 230 is an image capturing device such as a scanner, a camera, and the like. The image forming apparatus 200 includes an automatic document feeder 232 which conveys sheets one by one loaded on a sheet feed tray 231 to the image reading section 230. The image reading section 230 reads images from the sheets conveyed from the automatic document feeder 232 under the control of the control section 290.

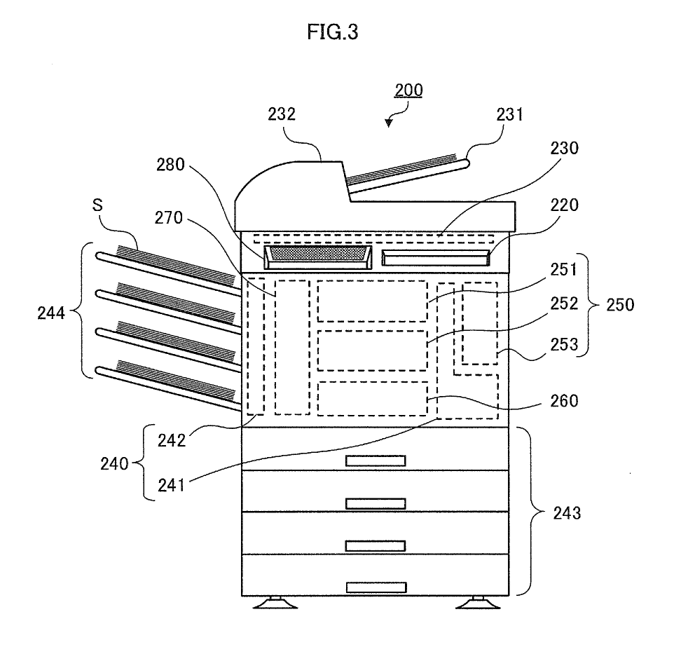

The sheet feeding and discharging section 240 is a section for feeding and discharging sheets. FIG. 3 is an example of the image forming apparatus 200. The sheet feeding and discharging section 240 includes a sheet feeding section 241 and a sheet discharging section 242. The image forming apparatus 200 includes a stacker 244. The stacker 244 includes a plurality of sheet discharge trays.

The sheet feeding section 241 is a device for suppling sheets to the printing section 250. For example, the sheet feeding section 241 supplies sheets loaded on a sheet feed tray 243 to the printing section 250. The sheet discharging section 242 is a device for discharging sheets printed by the printing section 250 to the outside. For example, the sheet discharging section 242 discharges the sheet to anyone of sheet discharge trays.

The printing section 250 is a printing unit for executing printing on the sheet. The printing section 250 includes a decolorable printing section 251, a non-decolorable printing section 252 and a sheet reversing unit 253.

The decolorable printing section 251 is a printing unit for printing an image on the sheet with the use of a decolorable color material. The decolorable printing section 251 is a first printing section of the image forming apparatus 200. The decolorable color material is, for example, decolorable ink. The decolorable ink is an erasable ink by applying heat, light or chemical processing. For example, the decolorable ink is an ink which can be decolored/erased by means of applying heat more than a predetermined temperature (hereinafter, referred to as a “decoloring temperature”), emitting light including predetermined wavelength components such as ultraviolet, and applying the ink containing predetermined components. The decolorable ink can be rephrased as erasable ink or a color fadable ink. Note that, the concept of the decolorable material includes not only a liquid decolorable color material, but also a powdered decolorable color material. The powdered decolorable color material can be rephrased as a decolorable toner, an erasable toner, or a color fadable toner. Hereinafter, a printing using the decolorable color material is referred to as a “decolorable printing”.

The decolorable printing section 251 is an electrophotographic type printing unit used in, for example, a laser printer or an LED (Light Emitting Diode) printer. The decolorable printing section 251 may be a printing unit other than the electrophotographic type. For example, the decolorable printing section 251 may be an inkjet type printing unit used in a inkjet printer, a thermal type printing unit used in a thermal printer, and a dot impact type printing unit used in a dot impact printer.

The decolorable printing section 251 includes, for example, an image carrier such as a photoconductive drum, a transfer section which transfers a toner image developed on the image carrier to the sheet, and a fixing section which fixes the toner image transferred to the sheet on the sheet through heating and pressure. The fixing section includes a heat roller for heating to a fixing temperature, and a pressure roller for applying pressure on the sheet.

The non-decolorable printing section 252 is a printing unit for printing the image on the sheet with the use of a non-decolorable color material. The non-decolorable printing section 252 is a second printing section of the image forming apparatus 200. The non-decolorable color material is, for example, permanent ink. The permanent ink is a general ink (in other words, a non-decolorable ink or a non-erasable ink) which is not the decolorable ink. Note that, the concept of the non-decolorable color material includes not only a liquid non-decolorable color material, but also a powdered non-decolorable color material. The powdered non-decolorable color material can be rephrased as a permanent toner, a non-decolorable toner, a non-erasable toner, or a general toner. Hereinafter, a printing using the non-decolorable color material is referred to as a non-decolorable printing.

The non-decolorable printing section 252 is, for example, an electrophotographic type printing unit. The non-decolorable printing section 252 maybe a printing unit other than the electrophotographic type. For example, the non-decolorable printing section 252 may be an inkjet type printing unit used in a inkjet printer, a thermal type printing unit used in a thermal printer, a dot impact type printing unit used in a dot impact printer, and the like.

The non-decolorable printing section 252 includes, for example, the image carrier, the transfer section, and the fixing section, as similar to the decolorable printing section 251. Further, part of the non-decolorable printing section 252 may be the same mechanisms as that of the decolorable printing section 251. For example, the decolorable printing section 251 and the non-decolorable printing section 252 may share the image carrier, the transfer section and the fixing section.

The sheet reversing unit 253 is a unit for reversing the sheet. The sheet reversing unit 253 enables the decolorable printing section 251 and the non-decolorable printing section 252 to execute the duplex printing.

The decoloring section 260 is a unit for erasing an image formed by using the decolorable color material (Hereinafter, an image formed by using the decolorable color material is referred to as a decolorable image). For example, the decoloring section 260 includes the heat roller for heating the sheet to the decoloring temperature and the pressure roller for applying the pressure on the sheet. The decoloring section 260 heats the sheet to erase the decolorable image on the sheet. Further, if the printing section 250 is the electrophotographic type printing unit, the fixing section included in the printing section 250 may have the functions of the decoloring section 260. That is, the decoloring section 260 and the fixing section included in the printing section 250 may be a common mechanism.

The processing section 270 is a device for processing the sheet printed by the printing section 250. The processing section 270 includes, for example, a stapler for stapling sheets and a hole puncher for punching holes in the sheet. The processing section 270 staples sheets or punches holes under the control of the control section 290.

The output section 280 outputs various kinds of information to the user. For example, the output section 280 is a display device such as a liquid crystal display and the like, or a sound generator such as a speaker and the like.

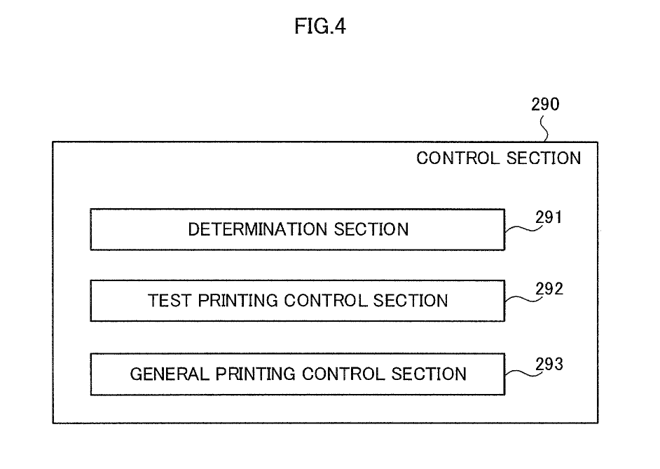

The control section 290 is a processing unit such as a processor and the like. The control section 290 functions as a control device controlling the image forming apparatus 200. The control section 290 operates according to a program stored in an ROM (Read Only Memory) and/or an RAM (Random Access Memory) (not shown) to enable various operations including “printing processing” which will be described later. The control section 290, as shown in FIG. 4, functions as a determination section 291, a test printing control section 292, and a general printing control section 293 by operating according to the program. The control section 290 may be configured of one processor or a plurality of processors. If the control section 290 configured of a plurality of processors, the control section 290 may accomplish the printing processing in cooperation between the processors.

Next, the operations of the image forming apparatus 200 with such a constitution are described.

If receiving the printing command from the user, the control section 290 starts the printing processing. The printing command is sent from the user terminal 100 or the operation section 220. For example, if the user sets a document on the sheet feed tray 231 and presses a copy start button in the operation section 220, the image reading section 230 scans the document, and the operation section 220 sends the printing command for printing the scanned image to the control section 290. For another example, if the user selects the printing subject image on the user terminal 100 and presses the print start button displayed on the user terminal 100, the user terminal 100 sends the printing command for printing the selected image to the control section 290 through the network. In the following description, it is assumed that image information and print setting information are included in the printing command.

The image information is the information of the printing subject image. If the printing command is sent from the operation section 220, the image information is the image scanned by the image reading section 230. If the printing command is sent from the user terminal 100, the image information is the image selected by the user operating the user terminal 100 as a print target.

The print setting information is the information in which printing settings used by the general printing control section 293 are recorded. For example, the print setting information is the information for determining that the printing executed by the general printing control section 293 is either the duplex printing or a simplex printing, and either the decolorable printing or the non-decolorable printing. Printing settings included in the print setting information is not limited to the above information. For example, the print setting information may include a printing setting for determining the number of print copies, a printing setting for determining whether the processing of the sheet is executed, and a printing setting for determining whether the test printing is executed.

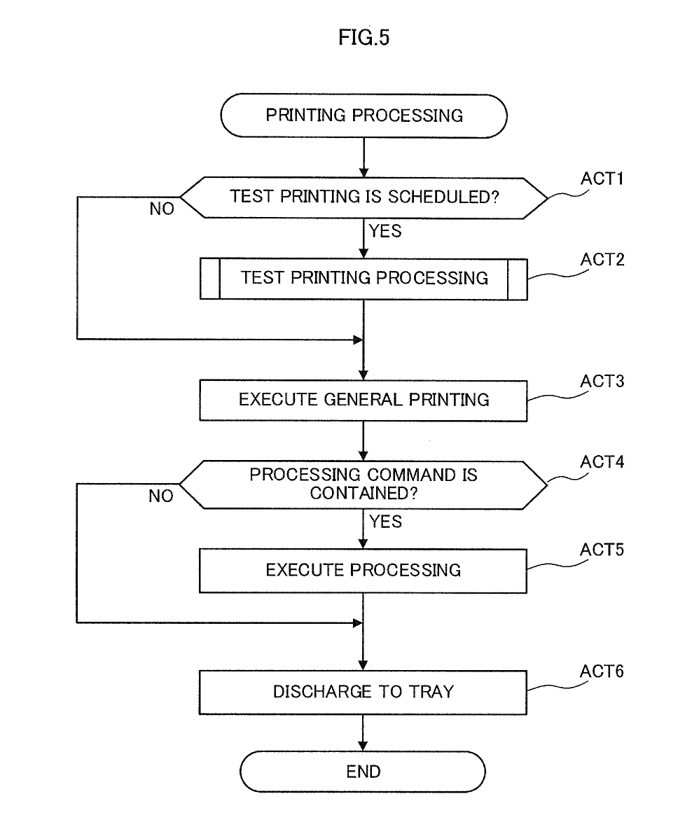

Hereinafter, the printing processing is described with reference to the flowchart in FIG. 5.

First, the determination section 291 determines based on the print setting information whether the test printing is scheduled (ACT 1). If the test printing is not scheduled (NO in ACT 1), the processing goes to ACT 3.

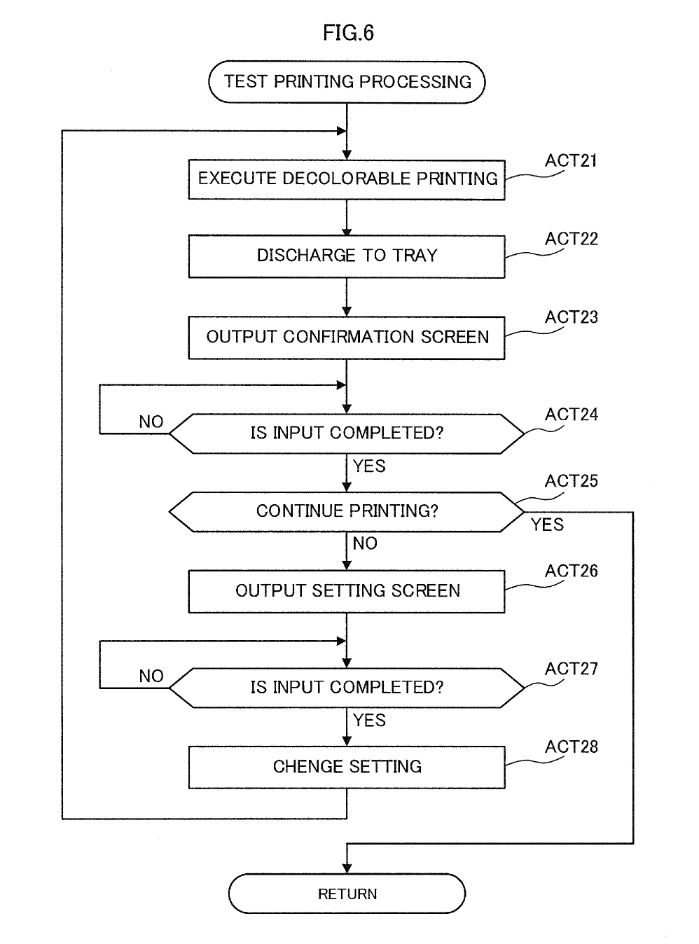

If the test printing is scheduled (YES in ACT 1), the test printing control section 292 starts the test printing processing (ACT 2). Hereinafter, the test printing processing is described with reference to the flowchart in FIG. 6.

First, the test printing control section 292 execute the decolorable printing of the printing subject image by controlling the decolorable printing section 251 (ACT 21). If the duplex printing is scheduled by the printing setting, the test printing control section 292 executes the duplex printing by controlling the sheet reversing unit 253. Note that, even if the multiple copies is scheduled by the printing setting, the test printing control section 292 does not print multiple copies. In this case, the test printing control section 292 prints only one copy.

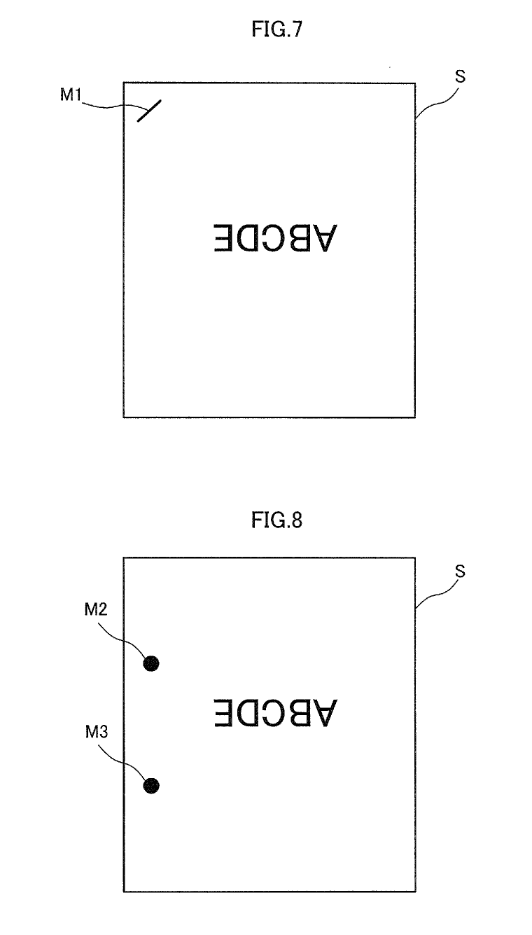

Note that, even if the processing of the sheet is scheduled by the printing setting, the test printing control section 292 does not process the sheet S. In this case, the test printing control section 292 prints a mark at a place where a processing by the general printing control section 293 is scheduled. For example, if the stapling is scheduled by the printing setting, the test printing control section 292 prints a line of which the length is the same as the staple, as M1 shown in FIG. 7, at a place where a stapling by the general printing control section 293 is scheduled. Further, if the punching holes is scheduled by the printing setting, the test printing control section 292 prints circles of which the size is the same as punch holes, as M2 and M3 shown in FIG. 8, at a place the punching by the general printing control section 293 is scheduled.

When the decolorable printing is completed, the test printing control section 292 discharges the sheet to any sheet discharge tray on the stacker 244 by controlling the sheet discharging section 242 (ACT 22).

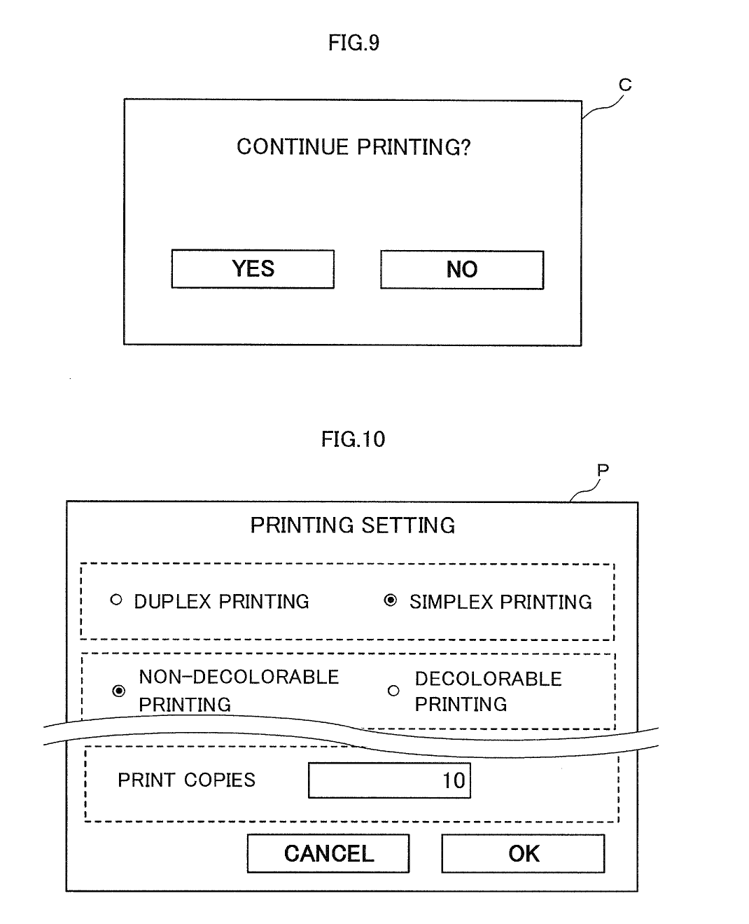

Next, the test printing control section 292 outputs a confirmation screen C to the output section 280 (ACT 23). The confirmation screen C is a screen for confirming whether the printing in the current printing setting is continued towards the user. The FIG. 9 is an example of the confirmation screen C. If the printing command is sent from the operation section 220, the test printing control section 292 displays the confirmation screen C on the output section 280. If the printing command is sent from the user terminal 100, the test printing control section 292 commands the user terminal 100 to display the confirmation screen C on a display of the user terminal 100.

The test printing control section 292 determines whether there is an input from the user (ACT 24). In the example of FIG. 9, the test printing control section 292 determines whether a “YES” button is pressed or a “NO” button is pressed by the user. If there is no input from the user (NO in ACT 24), the test printing control section 292 repeats the processing in ACT 24 until there is an input from the user.

If there is the input from the user (YES in ACT 24), the test printing control section 292 determines that the input from the user is either a printing continuation command or a printing interruption command (ACT 25). Note that, the printing continuation command is a command to continue the printing in the current printing setting. In the example of FIG. 9, the printing continuation command is a command sent to the control section 290 from the operation section 220 or the user terminal 100 in case the user presses the “YES” button. Further, the printing interruption command is a command to interrupt the printing. In the example of FIG. 9, the printing interruption command is a command sent to the control section 290 from the operation section 220 or the user terminal 100 in case the user presses the “NO” button.

If the input from the user is the printing continuation command (YES in ACT 25), the test printing control section 292 terminates the test printing processing and returns to the flowchart in FIG. 5.

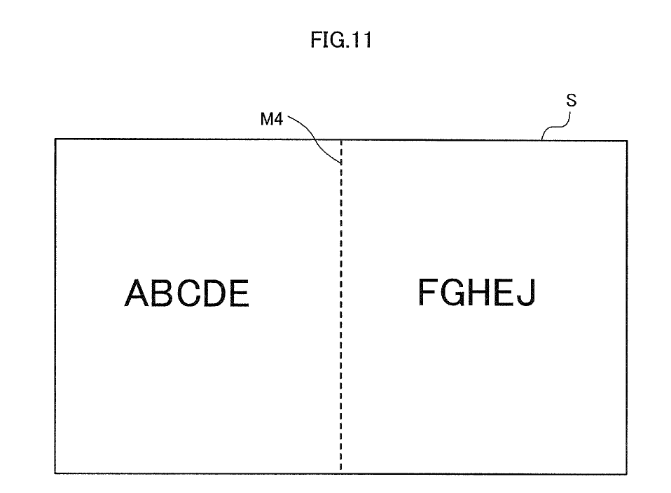

In FIG. 7 and FIG. 8, the position of the staple and the position of the punch hole are unnatural. In this case, the user inputs the printing interruption command. If the input from the user is the printing interruption command (NO in ACT 25), the test printing control section 292 outputs a printing setting screen P to the output section 280 (ACT 26). The printing setting screen P is a screen for changing the printing setting. FIG. 10 is an example of the printing setting screen P. If the printing command is sent from the operation section 220, the test printing control section 292 displays the printing setting screen P on the output section 280. If the printing command is sent from the user terminal 100, the test printing control section 292 commands the user terminal 100 to display the printing setting screen P on the display of the user terminal 100.

Next, the test printing control section 292 determines whether there is an input from the user (ACT 27). In the example of FIG. 10, the test printing control section 292 determines whether the “OK” button is pressed by the user. If there is no input from the user (NO in ACT 27), the test printing control section 292 repeats the processing in ACT 27 until there is the input from the user.

If there is the input from the user (YES in ACT 27), the test printing control section 292 changes the printing setting according to the information input to the printing setting screen P (ACT 28). When the changing of the setting is completed, the test printing control section 292 returns to the processing in ACT 21, and executes the decolorable printing of the image again in accordance with the changed printing setting.

Return to FIG. 5, the general printing control section 293 prints the image in accordance with the printing setting (ACT 3). If the printing setting has been changed in ACT 28, the image is printed in accordance with the changed printing setting. If the non-decolorable printing is scheduled by the printing setting, the general printing control section 293 executes the non-decolorable printing of the image by controlling the non-decolorable printing section 252. If the decolorable printing is scheduled by the printing setting, the general printing control section 293 executes the decolorable printing of the image by controlling the decolorable printing section 251.

The general printing control section 293 determines based on the printing setting whether the sheet processing is scheduled (ACT 4). If the sheet processing is not scheduled (NO in ACT 4), the general printing control section 293 goes to ACT 6.

If the sheet processing is not scheduled (YES in ACT 4), the general printing control section 293 controls the processing section 270 to process the sheet (ACT 5). For example, if the printing setting is the setting for stapling the sheet, the general printing control section 293 staples the sheet by controlling the stapler of the processing section 270. If the printing setting is the setting for punching holes in the sheet, the general printing control section 293 punches holes in the sheet by controlling the hole puncher of the processing section 270.

When the printing is completed, the general printing control section 293 discharges the sheet to the stacker 244 by controlling the sheet discharging section 242 (ACT 6). If the multiple copies are printed in ACT3, the general printing control section 293 may discharge each of multiple copies separately to sheet discharge trays. When the discharge is completed, the control section 290 terminates the printing processing.

In accordance with the present embodiment, the test printing is the decolorable printing. Therefore, in case in which the result of the test printing does not meet the intended result of the user, the user decolors the sheet and recycles the decolored sheet. Therefore, the user does not waste the sheet through the test printing.

Note that the embodiment described above is an example, and various modifications and applications are possible.

For example, in the embodiment described above, the processing section 270 includes the stapler and the hole puncher; however, the processing section 270 may include a folding mechanism for bending the sheet. After the general printing control section 293 has completed the printing of the image on the sheet, the processing section 270 may bend the sheet under the control of the general printing control section 293. At this time, the test printing control section 292 may print a mark at a place where the bending is scheduled, without bending the sheet. For example, the test printing control section 292 may print a dashed line, as M4 shown in FIG. 11, at the place where the bending by the processing section 270 is scheduled. The processing section 270 may be a binding mechanism which bends a plurality of sheets and staples the bent place. The binding mechanism is one form of the folding mechanism.

Further, the test printing control section 292 may decolor the sheet the test printing is scheduled, by controlling the decoloring section 260, before executing the decolorable printing in ACT 21. Whether to execute the decoloring processing may be determined based on printing settings included in the printing command. Then, the test printing control section 292 may picks up the sheet from a predetermined sheet feed tray in the plurality of sheet feed trays 243, and decolor the picked-up sheet, and sequentially, execute the test printing on the sheet the decoloring processing has been executed. The tray the sheet is picked up is, for example, a tray designated by the user as a tray for storing the sheet on which the test printing has been executed (hereinafter, this tray is referred to as a “designation tray”). By simply storing the sheet subjected to test printing in the designation tray as it is, the decoloring processing and the test printing are automatically executed. Therefore, the time of the user can be saved.

The test printing control section 292 may be constituted so as to notify the user that the printed sheet is the sheet which was executed the test printing, in order that the user does not wrongly use the sheet which was executed the test printing.

For example, the test printing control section 292 may output attention information to the output section 280 when discharging the sheet to the sheet discharge tray in ACT 22. The attention information is information to encourage the user to pay attention. For example, the attention information may be information to indicate that the printed sheet is a sheet which was executed the test printing, and may be information that contain a message for encouraging the user to return the sheet to the designation tray after the user confirms the printing result. The attention information may be text information displayed on the display, or may be a sound message output to a speaker. The attention information may be only a buzzer sound. In a case in which the printing command is sent from the user terminal 100, the test printing control section 292 may command the user terminal 100 to output the attention information.

Further, the test printing control section 292 may print the attention information in addition to the printing subject image on the sheet when executing the decolorable printing in ACT 21. The attention information may be a text such as “Confidential” and the like. If the printing command is a command to execute a simplex printing of the printing subject image, the test printing control section 292 may print the attention information on an opposite side of a surface on which the printing subject image is printed. At this time, the test printing control section 292 may apply the decolorable printing to both the printing subject image and the attention information, or may apply the decolorable printing to the printing subject image and apply the non-decolorable printing to the attention information. Although the image on the decolored sheet is seemed to be disappeared, the decolorable color material is still left on the sheet. Therefore, in case in which the user uses the test printed sheet for purpose other than the test printing such as the general printing, there is a risk that the confidential information is leaked to outside. However, even if the user decolors the sheet, the attention information does not disappear from the sheet because the printing of the attention information is the non-decolorable printing. Thus, user mistakes, for example the use of the test printed sheet for purpose other than the test printing, can be reduced.

In the embodiment described above, the printing section 250 is described as the electrophotographic type printing unit; however, the printing section 250 may be a printing unit other than the electrophotographic type. For example, the printing section 250 may be an inkjet system, a thermal system, a dot impact system and the like.

The image forming apparatus 200 is described as the copier; however, the image forming apparatus 200 may not have a copy function. The image forming apparatus 200 may be a mere printer.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image forming apparatus, comprising:
a printing section configured to execute at least a decolorable printing;
an input section configured to receive a command from a user;
a first print control section configured to execute a test printing of a printing subject image by controlling the printing section when receiving a printing command from the user, and then wait until a command is input from the user; and
a second print control section configured to print the printing subject image when receiving a command to continue printing from the user after the test printing is executed by the first print control section; wherein
the test printing executed by the first print control section is the decolorable printing.

2. The image forming apparatus according to claim 1, wherein
the printing section comprises a first printing section configured to execute the decolorable printing and a second printing section configured to execute a non-decolorable printing; wherein
the first print control section executes the decolorable printing of the printing subject image by controlling the first printing section when receiving the printing command from the user; and
the second print control section executes the non-decolorable printing of the printing subject image by controlling the second printing section when receiving the command to continue printing from the user.

3. The image forming apparatus according to claim 1, further comprising:
a processing section configured to process a sheet on which the printing subject image is printed; wherein
the first print control section execute the decolorable printing of a preset mark on a place where a processing of the processing section is scheduled, in case where a processing command to process the sheet is contained in the printing command; and
the second print control section processes the sheet by controlling the processing section in accordance with the processing command.

4. The image forming apparatus according to claim 3, wherein
the processing section comprises a stapler; wherein
the first print control section execute the decolorable printing of a preset mark on the place where a stapling of the stapler is scheduled, in case where the processing command to staple the sheet is contained in the printing command; and
the second print control section staples the sheet by controlling the processing section in accordance with the processing command.

5. The image forming apparatus according to claim 3, wherein
the processing section includes a hole puncher; wherein
the first print control section execute the decolorable printing of a preset mark on the place where a punching of the hole puncher is scheduled, in case where the processing command to punch a hole is contained in the printing command; and
the second print control section punches the hole in the sheet by controlling the processing section in accordance with the processing command.

6. The image forming apparatus according to claim 1, further comprising:
a decoloring section configured to decolor a decolorable image formed by the, decolorable printing; wherein
the first print control section decolors the decolorable image on a sheet by controlling the decoloring section, before executing the decolorable printing on the sheet.

7. The image forming apparatus according to claim 1, wherein
the first print control section prints attention information for encouraging the user to pay attention, in addition to the printing subject image.

8. The image forming apparatus according to claim 7, wherein
the printing section comprises a first printing section configured to execute the decolorable printing and a second printing section configured to execute a non-decolorable printing; wherein
the first print control section executes the decolorable printing of the printing subject image by controlling the first printing section and executes the non-decolorable printing of the attention information by controlling the second printing section.

9. The image forming apparatus according to claim 7, further comprising:
a sheet reversing unit configured to enable the first print control section to execute a duplex printing by reversing the sheet; wherein
the first print control section prints the attention information on an opposite side of a surface on which the printing subject image is printed, in case where the printing command is a command to execute a simplex printing of the printing subject image.

10. A printing method, comprising:
a first print control step of executing a test printing of a printing subject image when receiving a printing command from the user, and then waiting until a command is input from a user;
a second print control step of printing the printing subject image when receiving a command to continue printing from the user after the test printing is executed in the first print control step; wherein
the test printing executed in the first print control step is a decolorable printing.
